(19) United States
(12) Patent Application Publication
(10) Pub. No.: US 2017/0168850 A1
(43) Pub. Date: Jun. 15, 2017

(54) METHOD OF DOWNLOADING CONFIGURATION CODE, SYSTEM AND TIMER/COUNTER CONTROL REGISTER

(71) Applicant: Shenzhen China Star Optoelectronics Technology Co., Ltd., Shenzhen, Guangdong (CN)

(72) Inventors: Jianjun XIE, Shenzhen, Guangdong (CN); Wenqin ZHAO, Shenzhen, Guangdong (CN); Lei SUN, Shenzhen, Guangdong (CN); Tao HE, Shenzhen, Guangdong (CN); Xiaobin BI, Shenzhen, Guangdong (CN)

(73) Assignee: Shenzhen China Star Optoelectronics Technology Co., Ltd., Shenzhen, Guangdong (CN)

(21) Appl. No.: 14/905,059

(22) PCT Filed: Sep. 24, 2015
(86) PCT No.: PCT/CN2015/090539

§ 371 Date: Jan. 14, 2016

(30) Foreign Application Priority Data
Jul. 31, 2015 (CN) 201510464745.8

(51) Int. Cl. G06F 9/44; G06F 9/445; H04L 29/08

(52) U.S. Cl. CPC G06F 9/4411; H04L 67/34; G06F 9/44505; G06F 9/4401

(57) ABSTRACT

The present invention provides a method of downloading a configuration code, applied in a timer/counter control register, and the method comprises steps of acquiring a first boot code through a first default interface of the timer/counter control register; calculating a first check code according to the acquired first boot code; determining whether the calculated first check code and a first standard check code are the same; as the two are the same, downloading the configuration code from the storage element coupled to the first default interface through the first default interface; as the two are different, downloading the configuration code from a storage element coupled to a second default interface through the second default interface of the timer/counter control register. Therefore, the present invention promote the utility flexibility of the timer/counter control register. The present invention further provides a system of downloading a configuration code and a timer/counter control register.

### CROSS REFERENCE

This application claims the priority of Chinese Patent Application No. 201510464745.8, entitled “Method of downloading configuration code, system and timer/counter control register”, filed on Jul. 31, 2015, the disclosure of which is incorporated herein by reference in its entirety.

### FIELD OF THE INVENTION

The present invention relates to a storage driving field, and more particularly to a method of downloading a configuration code, a system and a timer/counter control register.

### BACKGROUND OF THE INVENTION

At present, depending on the boot code capacity and procurement costs, the timer/counter control register generally will externally coupled with an EEPROM or a Flash to store the configuration code of the timer/counter control register, and the storage devices option is determined. In this embodiment, the method of downloading the configuration code comprises steps of acquiring a first boot code through a first default interface of the timer/counter control register; calculating a first check code according to the acquired first boot code; determining whether the calculated first check code and a first standard check code are the same; as the calculated first check code and the first standard check code are the same, downloading the configuration code from the storage element coupled to the first default interface through the first default interface; as the calculated first check code and the first standard check code are different, downloading the configuration code from a storage element coupled to a second default interface through the second default interface of the timer/counter control register. However, the timers/counter control register generally will regularly select the EEPROM or the Flash to download the configuration code, the functionality is relatively simple, and the configuration is inflexible.

### SUMMARY OF THE INVENTION

An objective of the present invention is to provide a method of downloading a configuration code, a system and a timer/counter control register for promoting the utility flexibility of the timer/counter control register.

For realizing the aforesaid objective, the technical solution provided by the embodiments of the present invention is:

The present invention provides a method of downloading a configuration code, applied in a timer/counter control register, and employed to automatically identify a storage element coupled to the timer/counter control register and to download the configuration code from the identified storage element, and the method comprises:

acquiring a first boot code through a first default interface of the timer/counter control register;

calculating a first check code according to the acquired first boot code;

determining whether the calculated first check code and a first standard check code are the same;

as the calculated first check code and the first standard check code are the same, downloading the configuration code from the storage element coupled to the first default interface through the first default interface;

as the calculated first check code and the first standard check code are different, downloading the configuration code from a storage element coupled to a second default interface through the second default interface of the timer/counter control register.

As the calculated first check code and the first standard check code are different, the step of downloading the configuration code from a storage element coupled to a second default interface through the second default interface of the timer/counter control register comprises:

acquiring a second boot code through the second default interface of the timer/counter control register;

calculating a second check code according to the acquired second boot code;

confirming that the calculated second check code and the second standard check code are the same, and keeping downloading the configuration code from the storage element coupled to the second default interface.

After the step of calculating the second check code according to the acquired second boot code, the method further comprises:

confirming that the calculated second check code and the second standard check code are different, and stopping downloading the configuration code from the storage element coupled to the second default interface.

The first default interface is an IIC interface, and the second default interface is a SPI interface.

The present invention further provides a system of downloading a configuration code, applied in a timer/counter control register, and employed to automatically identify a storage element coupled to the timer/counter control register and to download the configuration code from the identified storage element, wherein the system of downloading the configuration code comprises:

an acquiring module, acquiring a first boot code through a first default interface of the timer/counter control register;

a calculating module, calculating a first check code according to the acquired first boot code;

a determining module, determining whether the calculated first check code and a first standard check code are the same; and outputting a first downloading instruction as the calculated first check code and the first standard check code are the same; and outputting a second downloading instruction as the calculated first check code and the first standard check code are different;

a downloading module, downloading the configuration code from the storage element coupled to the first default interface through the first default interface according to the first downloading instruction; and downloading the configuration code from a storage element coupled to a second default interface through the second default interface of the timer/counter control register according to the second downloading instruction.

The acquiring module further acquires a second boot code through the second default interface of the timer/counter control register; the calculating module further calculates a second check code according to the acquired second boot code; the determining module further keeps outputting the second downloading instruction to make the downloading module keep downloading the configuration code from the storage element coupled to the second default interface as confirming that the calculated second check code and the second standard check code are the same.

The determining module outputs a stop instruction as confirming that the calculated second check code and the second standard check code are different, and the downloading module stops downloading the configuration code from the storage element coupled to the second default interface as receiving the stop instruction.

The present invention further provides a timer/counter control register, employed to download a configuration code from a first storage element or a second storage element, wherein: the timer/counter control register comprises a first default interface, a second default interface and a system of downloading the configuration code, and the first default interface is employed to couple to the first storage element, and the second default interface is employed to couple to the second storage element, and the system of downloading the configuration code downloads the configuration code from the corresponding storage element through the first default interface or the second default interface, and the system of downloading the configuration code comprises:

an acquiring module, acquiring a first boot code through a first default interface of the timer/counter control register;

a calculating module, calculating a first check code according to the acquired first boot code;

a determining module, determining whether the calculated first check code and a first standard check code are the same; and outputting a first downloading instruction as the calculated first check code and the first standard check code are the same; and outputting a second downloading instruction as the calculated first check code and the first standard check code are different;

a downloading module, downloading the configuration code from the storage element coupled to the first default interface through the first default interface according to the first downloading instruction; and downloading the configuration code from a storage element coupled to a second default interface through the second default interface of the timer/counter control register according to the second downloading instruction.

The acquiring module further acquires a second boot code through the second default interface of the timer/counter control register; the calculating module further calculates a second check code according to the acquired second boot code; the determining module further keeps outputting the second downloading instruction to make the downloading module keep downloading the configuration code from the storage element coupled to the second default interface as confirming that the calculated second check code and the second standard check code are the same.

The determining module outputs a stop instruction as confirming that the calculated second check code and the second standard check code are different, and the downloading module stops downloading the configuration code from the storage element coupled to the second default interface as receiving the stop instruction.

The first default interface is an IIC interface, and the second default interface is a SPI interface, and the first default interface is further coupled to a voltage end through a corresponding resistance.

The method of downloading the configuration code according to the present invention is applied in a timer/counter control register, and employed to automatically identify a storage element coupled to the timer/counter control register and to download the configuration code from the identified storage element. The method comprises steps of acquiring a first boot code through a first default interface of the timer/counter control register; calculating a first check code according to the acquired first boot code; determining whether the calculated first check code and a first standard check code are the same; as the calculated first check code and the first standard check code are the same, downloading the configuration code from the storage element coupled to the first default interface through the first default interface; as the calculated first check code and the first standard check code are different, downloading the configuration code from a storage element coupled to a second default interface through the second default interface of the timer/counter control register. Therefore, the present invention can arrange the timer/counter control register to be coupled with a plurality of storage elements, and selectively downloads the configuration code from one of the storage elements according to the requirement, and thus to promote the utility flexibility of the timer/counter control register.

### BRIEF DESCRIPTION OF THE DRAWINGS

In order to more clearly illustrate the embodiments of the present invention, the following figures will be described in the embodiments are briefly introduced. It is obvious that the drawings are only some embodiments of the present invention, those of ordinary skill in this field can obtain other figures according to these figures without paying the premise.

FIG. 1 is a flowchart of a method of downloading a configuration code provided by the first embodiment of the present invention;

FIG. 2 is a specific flowchart diagram of the step 105 in FIG. 1;

FIG. 3 is a block diagram of a system of downloading a configuration code provided by the second embodiment of the present invention;

FIG. 4 is a diagram of a timer/counter control register provided by the third embodiment of the present invention;

FIG. 5 is a block diagram of the system of downloading the configuration code in the timer/counter control register shown in FIG. 3.

### DETAILED DESCRIPTION OF PREFERRED EMBODIMENTS

For better explaining the technical solution and the effect of the present invention, the present invention will be further described in detail with the accompanying drawings in the specific embodiments.

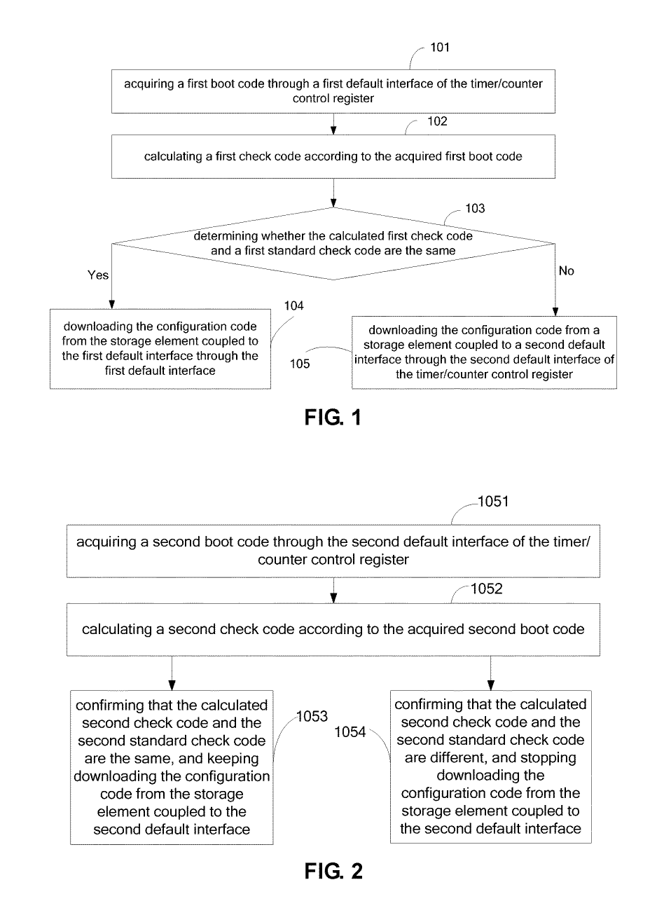

Please refer to FIG. 1, which shows a method of downloading a configuration code provided by the first embodiment of the present invention. The method is applied in a timer/counter control register, and employed to automatically identify a storage element coupled to the timer/counter control register and to download the configuration code from the identified storage element. The method comprises:

step 101, acquiring a first boot code through a first default interface of the timer/counter control register.

Specifically, the timer/counter control register comprises a first default interface and a second default interface. The first default interface and the second default interface are different. The first default interface is employed to couple to a first storage element, and the second default interface is employed to couple to a second storage element, and the first storage element and the second storage element are different. The first storage element can be an EEPROM. The second storage element can be a FLASH. In this embodiment, the first default interface is an IIC interface, and the second default interface is a SPI interface.

step 102, calculating a first check code according to the acquired first boot code.

The first boot code is stored in the storage element coupled to the first default interface. The first boot code can be multiple digitals, such as codes C0-Cn. In this embodiment, n can be 7, and a length of the code is 8. The first check code is calculated according to the codes C0, C1, C2, C3, C4, C5, C6 and C7. In other embodiments, the value of n can be adjusted according to the actual condition.

step 103, determining whether the calculated first check code and a first standard check code are the same.

The timer/counter control register stores the first standard check code inside. The first standard check code is employed to be compared with the calculated first check code to confirm whether the first default interface is coupled with the corresponding storage element.

step 104, as the calculated first check code and the first standard check code are the same, downloading the configuration code from the storage element coupled to the first default interface through the first default interface.

Specifically, as confirming that the first check code and the first standard check code are the same, it indicates that the first default interface is coupled with the corresponding storage element and the configuration code can downloaded from the storage element.

step 105, as the calculated first check code and the first standard check code are different, downloading the configuration code from a storage element coupled to a second default interface through the second default interface of the timer/counter control register.

Specifically, as confirming that the first check code and the first standard check code are different, it indicates that the first default interface is coupled with the corresponding storage element and the second default interface is coupled with the corresponding storage element, thus, the configuration code can downloaded from the storage element coupled to the second default interface.

Please refer to FIG. 2. Selectively, the step 105 can further comprises steps of:

step 1051, acquiring a second boot code through the second default interface of the timer/counter control register.

step 1052, calculating a second check code according to the acquired second boot code.

The second boot code is stored in the storage element coupled to the second default interface. The second boot code can be multiple digitals, such as codes C0-Cn. In this embodiment, n can be 7, and a length of the code is 8. The second check code is calculated according to the codes C0, C1, C2, C3, C4, C5, C6 and C7. In other embodiments, the value of n can be adjusted according to the actual condition.

step 1053, confirming that the calculated second check code and the second standard check code are the same, and keeping downloading the configuration code from the storage element coupled to the second default interface.

Specifically, the timer/counter control register stores the second standard check code inside. The second standard check code is employed to be compared with the second check code of the storage element coupled with the second default interface to confirm whether the second default interface is coupled with the corresponding storage element.

Selectively, after the step 1052, the method further comprises:

step 1054, confirming that the calculated second check code and the second standard check code are different, and stopping downloading the configuration code from the storage element coupled to the second default interface.

As the second check code and the second standard check code are different, it indicates that the storage element coupled to the second default interface is not the corresponding storage element, i.e. the storage element coupled to the second default interface is incorrect, it needs to stop downloading the configuration code from the storage element coupled to the second default interface. Therefore, such determining method can promote the accuracy of downloading the configuration code.

In this embodiment, the method of downloading the configuration code comprises steps of acquiring a first boot code through a first default interface of the timer/counter control register; calculating a first check code according to the acquired first boot code; determining whether the calculated first check code and a first standard check code are the same; as the calculated first check code and the first standard check code are the same, downloading the configuration code from the storage element coupled to the first default interface through the first default interface; as the calculated first check code and the first standard check code are different, downloading the configuration code from a storage element coupled to a second default interface through the second default interface of the timer/counter control register. Therefore, the present invention can arrange the timer/counter control register to be coupled with a plurality of storage elements, and selectively downloads the configuration code from one of the storage elements according to the requirement, and thus to promote the utility flexibility of the timer/counter control register.

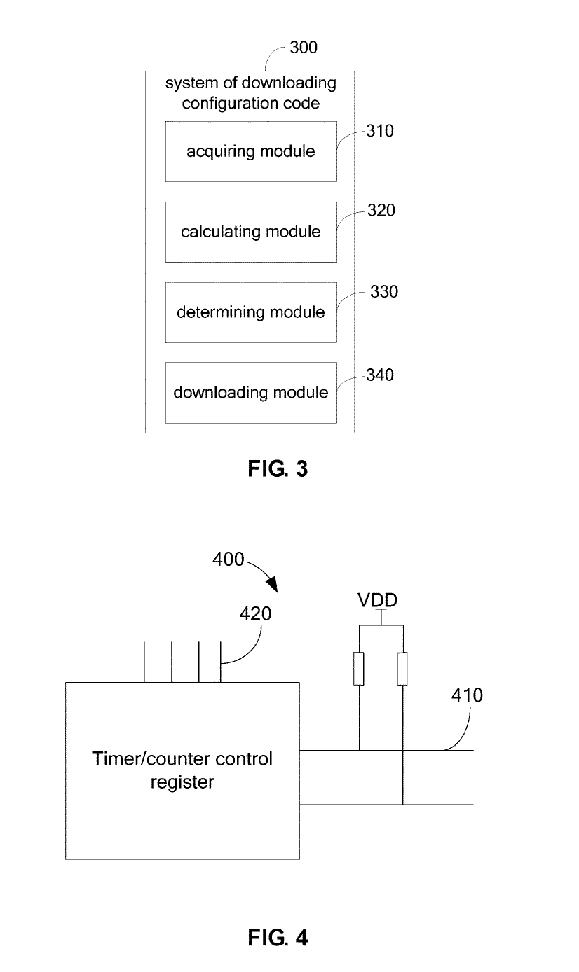

Please refer to FIG. 3, which shows a system 300 of downloading a configuration code provided by the second embodiment of the present invention. The system 300 of downloading the configuration code is applied in a timer/counter control register, and employed to automatically identify a storage element coupled to the timer/counter control register and to download the configuration code from the identified storage element. The system 300 of downloading the configuration code comprises an acquiring module 310, a calculating module 320, a determining module 330 and a downloading module 340.

The acquiring module 310 is employed to acquire a first boot code through a first default interface of the timer/counter control register.

Specifically, the timer/counter control register comprises a first default interface and a second default interface. The first default interface and the second default interface are different. The first default interface is employed to couple to a first storage element, and the second default interface is employed to couple to a second storage element, and the first storage element and the second storage element are different. The first storage element can be an EEPROM. The second storage element can be a FLASH. In this embodiment, the first default interface is an IIC interface, and the second default interface is a SPI interface.

The calculating module 320 is employed to calculate a first check code according to the acquired first boot code.

The first boot code is stored in the storage element coupled to the first default interface. The first boot code can be multiple digitals, such as codes C0-Cn. In this embodiment, n can be 7, and a length of the code is 8. The first check code is calculated according to the codes C0, C1, C2, C3, C4, C5, C6 and C7. In other embodiments, the value of n can be adjusted according to the actual condition.

The determining module 330 is employed to determine whether the calculated first check code and a first standard check code are the same; and outputting a first downloading instruction as the calculated first check code and the first standard check code are the same; and outputting a second downloading instruction as the calculated first check code and the first standard check code are different.

The timer/counter control register stores the first standard check code inside. The first standard check code is employed to be compared with the calculated first check code to confirm whether the first default interface is coupled with the corresponding storage element. As confirming that the first check code and the first standard check code are the same, it indicates that the first default interface is coupled with the corresponding storage element and the configuration code can downloaded from the storage element. As confirming that the first check code and the first standard check code are different, it indicates that the first default interface is coupled with the corresponding storage element and the second default interface is coupled with the corresponding storage element, thus, the configuration code can downloaded from the storage element coupled to the second default interface.

The downloading module 340 is employed to download the configuration code from the storage element coupled to the first default interface through the first default interface according to the first downloading instruction; and to download the configuration code from a storage element coupled to a second default interface through the second default interface of the timer/counter control register according to the second downloading instruction.

Furthermore, the acquiring module 310 is further employed to acquire a second boot code through a second default interface of the timer/counter control register. The calculating module 320 is further employed to calculate a second check code according to the acquired second boot code. The determining module 330 is further employed to keep outputting the second downloading instruction to make the downloading module 340 keep downloading the configuration code from the storage element coupled to the second default interface as confirming that the calculated second check code and the second standard check code are the same.

Specifically, the second boot code is stored in the storage element coupled to the second default interface. The second boot code can be multiple digitals, such as codes C0-Cn. In this embodiment, n can be 7, and a length of the code is 8. The second check code is calculated according to the codes C0, C1, C2, C3, C4, C5, C6 and C7. In other embodiments, the value of n can be adjusted according to the actual condition. The timer/counter control register stores the second standard check code inside. The second standard check code is employed to be compared with the second check code of the storage element coupled with the second default interface to confirm whether the second default interface is coupled with the corresponding storage element.

Furthermore, the determining module 330 outputs a stop instruction as confirming that the calculated second check code and the second standard check code are different. The downloading module 340 is further employed to stop downloading the configuration code from the storage element coupled to the second default interface as receiving the stop instruction.

As the second check code and the second standard check code are different, it indicates that the storage element coupled to the second default interface is not the corresponding storage element, i.e. the storage element coupled to the second default interface is incorrect, it needs to stop downloading the configuration code from the storage element coupled to the second default interface. Therefore, determining module 330 can promote the accuracy of downloading the configuration code.

In this embodiment, the system 300 of downloading the configuration code comprises an acquiring module 310, a calculating module 320, a determining module 330 and a downloading module 340. The acquiring module 310 is employed to acquire a first boot code through a first default interface of the timer/counter control register. The calculating module 320 is employed to calculate a first check code according to the acquired first boot code. The determining module 330 is employed to determine whether the calculated first check code and a first standard check code are the same; and outputting a first downloading instruction as the calculated first check code and the first standard check code are the same; and outputting a second downloading instruction as the calculated first check code and the first standard check code are different. The downloading module 340 is employed to download the configuration code from the storage element coupled to the first default interface through the first default interface according to the first downloading instruction; and to download the configuration code from a storage element coupled to a second default interface through the second default interface of the timer/counter control register according to the second downloading instruction. Therefore, the present invention can arrange the timer/counter control register to be coupled with a plurality of storage elements, and selectively downloads the configuration code from one of the storage elements according to the requirement, and thus to promote the utility flexibility of the timer/counter control register.

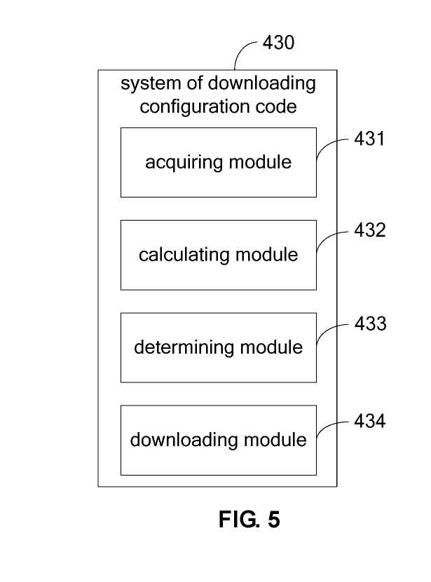

Please refer to FIG. 4 and FIG. 5, which shows a timer/counter control register 400 provided by the third embodiment of the present invention. The timer/counter control register 400 is employed to download a configuration code from a first storage element or a second storage element. The timer/counter control register 400 comprises a first default interface 410, a second default interface 420 and a system 430 of downloading the configuration code. The first default interface 410 is employed to couple to the first storage element. The second default interface 420 is employed to couple to the second storage element. The system 430 of downloading the configuration code downloads the configuration code from the corresponding storage element through the first default interface 410 or the second default interface 420. The system 430 of downloading the configuration code comprises an acquiring module 431, a calculating module 432, a determining module 433 and a downloading module 434.

The acquiring module 431 is employed to acquire a first boot code through a first default interface 410 of the timer/counter control register 400.

Specifically, the first default interface 410 and the second default interface 420 are different. The first storage element and the second storage element are different. The first storage element can be an EEPROM. The second storage element can be a FLASH. In this embodiment, the first default interface 410 is an IIC interface, and the second default interface 420 is a SPI interface. The amount of the first default interfaces 410 is two. The amount of the second default interfaces 420 is four.

The calculating module 432 is employed to calculate a first check code according to the acquired first boot code.

The first boot code is stored in the first storage element coupled to the first default interface 410. The first boot code can be multiple digitals, such as codes C0-Cn. In this embodiment, n can be 7, and a length of the code is 8. The first check code is calculated according to the codes C0, C1, C2, C3, C4, C5, C6 and C7. In other embodiments, the value of n can be adjusted according to the actual condition.

The determining module 433 is employed to determine whether the calculated first check code and a first standard check code are the same; and outputting a first downloading instruction as the calculated first check code and the first standard check code are the same; and outputting a second downloading instruction as the calculated first check code and the first standard check code are different.

The timer/counter control register 400 stores the first standard check code inside. The first standard check code is employed to be compared with the calculated first check code to confirm whether the first default interface 410 is coupled with the first storage element. As confirming that the first check code and the first standard check code are the same, it indicates that the first default interface 410 is coupled with the corresponding storage element and the configuration code can downloaded from the storage element. As confirming that the first check code and the first standard check code are different, it indicates that the first default interface 410 is coupled with the corresponding storage element and the second default interface 420 is coupled with the corresponding storage element, thus, the configuration code can downloaded from the storage element coupled to the second default interface 420.

The downloading module 434 is employed to download the configuration code from the storage element through the first default interface 410 according to the first downloading instruction; and to download the configuration code from the second storage element through the second default interface 420 according to the second downloading instruction.

Furthermore, the acquiring module 431 is further employed to acquire the second boot code through the second default interface 420. The calculating module 432 is further employed to calculate a second check code according to the acquired second boot code. The determining module 433 is further employed to keep outputting the second downloading instruction to make the downloading module 434 keep downloading the configuration code from the storage element as confirming that the calculated second check code and the second standard check code are the same.

Specifically, the second boot code is stored in the storage element coupled to the second default interface. The second boot code can be multiple digitals, such as codes C0-Cn. In this embodiment, n can be 7, and a length of the code is 8. The second check code is calculated according to the codes C0, C1, C2, C3, C4, C5, C6 and C7. In other embodiments, the value of n can be adjusted according to the actual condition. The timer/counter control register 400 stores the second standard check code inside. The second standard check code is employed to be compared with the second check code of the second storage element coupled with the second default interface 420 to confirm whether the second default interface 420 is correctly coupled with the second storage element.

Furthermore, the determining module 433 outputs a stop instruction as confirming that the calculated second check code and the second standard check code are different. The downloading module 434 is further employed to stop downloading the configuration code from the storage element coupled to the second default interface 420 as receiving the stop instruction.

As the second check code and the second standard check code are different, it indicates that the second default interface 420 is not coupled to the second storage element correctly, and it needs to stop downloading the configuration code from the storage element coupled to the second default interface. Therefore, determining module 433 can promote the accuracy of downloading the configuration code.

In this embodiment, the timer/counter control register 400 comprises a system 430 of downloading the configuration code. The system 430 of downloading the configuration code comprises an acquiring module 431, a calculating module 432, a determining module 433 and a downloading module 434. The acquiring module 431 is employed to acquire the first boot code through the first default interface 410. The calculating module 432 is employed to calculate a first check code according to the acquired first boot code. The determining module 433 is employed to determine whether the calculated first check code and a first standard check code are the same; and outputting a first downloading instruction as the calculated first check code and the first standard check code are the same; and outputting a second downloading instruction as the calculated first check code and the first standard check code are different. The downloading module 434 is employed to download the configuration code from the first storage element coupled to the first default interface through the first default interface according to the first downloading instruction; and to download the configuration code from the second storage element through the second default interface 420 according to the second downloading instruction. Therefore, the timer/counter control register 400 of the present invention can be coupled with a plurality of storage elements, and selectively downloads the configuration code from one of the storage elements according to the requirement, and thus to promote the utility flexibility of the timer/counter control register 400.

Selectively, the first default interface 410 is further coupled to a voltage end VDD through a corresponding resistance for acting the function of pulling up the voltage level to prevent the timer/counter control register 400 from misjudgment.

Above are only specific embodiments of the present invention, the scope of the present invention is not limited to this, and to any persons who are skilled in the art, change or replacement which is easily derived should be covered by the protected scope of the invention. Thus, the protected scope of the invention should go by the subject claims.

What is claimed is:

1. A method of downloading a configuration code, applied in a timer/counter control register, and employed to automatically identify a storage element coupled to the timer/counter control register and to download the configuration code from the identified storage element, and the method comprises:
acquiring a first boot code through a first default interface of the timer/counter control register;
calculating a first check code according to the acquired first boot code;
determining whether the calculated first check code and a first standard check code are the same;
as the calculated first check code and the first standard check code are the same, downloading the configuration code from the storage element coupled to the first default interface through the first default interface;
as the calculated first check code and the first standard check code are different, downloading the configuration code from a storage element coupled to a second default interface through the second default interface of the timer/counter control register.

2. The method of downloading configuration code according to claim 1, wherein as the calculated first check code and the first standard check code are different, the step of downloading the configuration code from a storage element coupled to a second default interface through the second default interface of the timer/counter control register comprises:
acquiring a second boot code through the second default interface of the timer/counter control register;
calculating a second check code according to the acquired second boot code;
confirming that the calculated second check code and the second standard check code are the same, and keeping downloading the configuration code from the storage element coupled to the second default interface.

3. The method of downloading configuration code according to claim 2, wherein after the step of calculating the second check code according to the acquired second boot code, the method further comprises:
confirming that the calculated second check code and the second standard check code are different, and stopping downloading the configuration code from the storage element coupled to the second default interface.

4. The method of downloading configuration code according to claim 1, wherein the first default interface is an IIC interface, and the second default interface is a SPI interface.

5. A system of downloading a configuration code, applied in a timer/counter control register, and employed to automatically identify a storage element coupled to the timer/counter control register and to download the configuration code from the identified storage element, wherein the system of downloading the configuration code comprises:
an acquiring module, acquiring a first boot code through a first default interface of the timer/counter control register;
a calculating module, calculating a first check code according to the acquired first boot code;
a determining module, determining whether the calculated first check code and a first standard check code are the same; and outputting a first downloading instruction as the calculated first check code and the first standard check code are the same; and outputting a second downloading instruction as the calculated first check code and the first standard check code are different;
a downloading module, downloading the configuration code from the storage element coupled to the first default interface through the first default interface according to the first downloading instruction; and downloading the configuration code from a storage element coupled to a second default interface through the second default interface of the timer/counter control register according to the second downloading instruction.

6. The system of downloading configuration code according to claim 5, wherein the acquiring module further acquires a second boot code through the second default interface of the timer/counter control register; the calculating module further calculates a second check code according to the acquired second boot code; the determining module further keeps outputting the second downloading instruction to make the downloading module keep downloading the configuration code from the storage element coupled to the second default interface as confirming that the calculated second check code and the second standard check code are the same.

7. The system of downloading configuration code according to claim 6, wherein the determining module outputs a stop instruction as confirming that the calculated second check code and the second standard check code are different, and the downloading module stops downloading the configuration code from the storage element coupled to the second default interface as receiving the stop instruction.

8. A timer/counter control register, employed to download a configuration code from a first storage element or a second storage element, wherein: the timer/counter control register comprises a first default interface, a second default interface and a system of downloading the configuration code, and the first default interface is employed to couple to the first storage element, and the second default interface is employed to couple to the second storage element, and the system of downloading the configuration code downloads the configuration code from the corresponding storage element through the first default interface or the second default interface, and the system of downloading the configuration code comprises:
an acquiring module, acquiring a first boot code through a first default interface of the timer/counter control register;
a calculating module, calculating a first check code according to the acquired first boot code;
a determining module, determining whether the calculated first check code and a first standard check code are the same; and outputting a first downloading instruction as the calculated first check code and the first standard check code are the same; and outputting a second downloading instruction as the calculated first check code and the first standard check code are different;
a downloading module, downloading the configuration code from the storage element coupled to the first default interface through the first default interface according to the first downloading instruction; and downloading the configuration code from a storage element coupled to a second default interface through the second default interface of the timer/counter control register according to the second downloading instruction.

9. The timer/counter control register according to claim 8, wherein the acquiring module further acquires a second boot code through the second default interface of the timer/counter control register; the calculating module further calculates a second check code according to the acquired second boot code; the determining module further keeps outputting the second downloading instruction to make the downloading module keep downloading the configuration code from the storage element coupled to the second default interface as confirming that the calculated second check code and the second standard check code are the same.

10. The timer/counter control register according to claim 9, wherein the determining module outputs a stop instruction as confirming that the calculated second check code and the second standard check code are different, and the downloading module stops downloading the configuration code from the storage element coupled to the second default interface as receiving the stop instruction.

11. The timer/counter control register according to claim 9, wherein the first default interface is an IIC interface, and the second default interface is a SPI interface, and the first default interface is further coupled to a voltage end through a corresponding resistance.
